(19) United States
(12) Patent Application Publication
(10) Pub. No.: US 2008/0161535 A1
(43) Pub. Date: Jul. 3, 2008

(54) THICKENING AND WETTING AGENTS

(76) Inventors: Michael S. Wiggins, Lansdale, PA (US); Douglas C. Rhubright, Harleysville, PA (US)

Correspondence Address: COGNIS CORPORATION;PATENT DEPARTMENT, 300 BROOKSIDE AVENUE, AMBLER, PA, 19002, US

(21) Appl. No.: 11/951,383

(22) Filed: Dec. 6, 2007

Related U.S. Application Data
(60) Provisional application No. 60/876,319, filed on Dec. 21, 2006.

(51) Int. Cl. C09F 1/04

(52) U.S. Cl. 530/210

(57) ABSTRACT

A rosin alcohol alkoxylated with 0-200 moles of at least one alkylene oxide selected from the group consisting of ethylene oxide, propylene oxide, butylene oxide, and combinations thereof per mole of alcohol is provided. A thickening agent and a method for making the thickening agent includes an alkoxylated rosin alcohol alkoxylated with 0-200 moles of at least one alkylene oxide selected from the group consisting of ethylene oxide, propylene oxide, butylene oxide, and combinations thereof per mole of alcohol where the alkoxylated rosin alcohol is reacted using a linking compound for linking at least two hydroxyl groups. The alkoxylated rosin alcohol and linking group may be reacted with a polyalkylene glycol. The alkoxylated rosin alcohol and thickening agent may be incorporated into an emulsion polymer or a polymer dispersion, or a paint or coating composition, as a wetting agent or rheology modifier, respectively.

### CROSS-REFERENCE TO RELATED APPLICATIONS

This application claims priority under 35 U.S.C. § 120 from U.S. Provisional Application No. 60/876,319, filed on Dec. 21, 2006, the entire disclosure of which is hereby incorporated by reference.

### BACKGROUND OF TEE INVENTION

1. Field of the Invention

The invention relates generally to thickening and wetting agents and methods for making the agents, and more particularly to thickening and wetting agents and methods for making the agents with a rosin alcohol.

2. Background Information

Aqueous systems may require thickeners for various types of applications. Many aqueous systems, including cosmetics, protective coatings for paper and metal, printing inks, and latex paints require the incorporation of thickeners to attain the appropriate Theological characteristics for the selected use. Substances useful as thickeners include natural polymers such as casein and alginates, and synthetic materials such as cellulose derivatives, acrylic polymers, and polyurethane polymers.

Aqueous systems may also require a wetting agent to modify the surface tension of a surface, for example, a pigment particle, or to alter the surface properties of a liquid by enhancing and facilitating emulsifying, dispersal, and spreading of a pigment contained therein, or to enhance the spread of a liquid on a surface, or to penetrate a liquid into a material. Wetting agents are also used in emulsion polymerization or polymeric dispersions, latex, paints and coatings. Wetting agents should have the appropriate performance and safety characteristics as the thickeners described herein.

Associative thickeners provide advantages over other classes of thickeners. For example, they are generally non-ionic, and stable to water. In addition, they are not typically sensitive to biodegradation. Associative thickeners contain hydrophobic moieties, either dispersed or localized along a hydrophilic backbone. A hydrophilic backbone may include polyurethanes, polyethers, and starch-type molecules.

Associative thickeners may be used in aqueous systems. The mechanism by which they thicken a system may involve hydrophobic associations between the hydrophobic species in the thickener molecule and other hydrophobic surfaces on other associative thickener molecules, or on molecules within the system. Associative thickeners include, but are not limited to, polyurethanes, hydrophobically-modified alkali soluble emulsions, hydrophobically modified hydroxyethyl cellulose, and hydrophobically modified polyacrylamides. The molecular weight and HLB (Hydrophilic-Lipophilic Balance) of the associative thickeners, which conventionally are water soluble or dispersible polymers, is selected to be sufficiently high to impart the desired Theological properties to an aqueous system.

A variety of polymeric materials may be used as a water-soluble polymer, including cellulose ethers, polyacrylamides, sulfonated polystyrenes, copolymers of acrylic acid, and hydroxypropylated guar, for example. The polymers tend to be highly viscous when present in high concentration in an aqueous solution. Reduction of viscosity with added agents, e.g., organic cosolvents, is possible, but the use of viscosity reducing agents may cause environmental problems (e.g., contribute to volatile organic compound content) or performance problems (e.g., added surfactants can detract from the performance of coating of a latex which contains the thickener).

Thickeners and wetting agents may contain alkylphenols, for example, nonylphenol. Due to environmental concerns, nonylphenol is being replaced with safer alternatives. In the European Union, nonylphenol has been banned as a hazard to human and environmental safety. Biochemically, p-nonylphenol and many of its derivatives act as xenostrogens, which are synthetic substances that differ from those produced by living organisms and imitate or enhance the effect of estrogens. The estrogenic stimulation is an unintended side-effect of these agents or their metabolites.

There remains a need for thickeners and wetting agents and methods for making thickeners and wetting agents that are effective, and safe for humans and the environment.

### SUMMARY OF THE INVENTION

Briefly described, according to an aspect of the invention, an alkoxylated rosin alcohol including a rosin alcohol alkoxylated with 0-200 moles of at least one alkylene oxide selected from the group consisting of ethylene oxide, propylene oxide, butylene oxide, and combinations thereof per mole of alcohol is provided.

According to another aspect of the invention, a method for making a thickening agent includes (a) providing an alkoxylated rosin alcohol alkoxylated with 0-200 moles of at least one alkylene oxide selected from ethylene oxide, propylene oxide, butylene oxide, and combinations thereof per mole of alcohol; and (b) reacting the alkoxylated rosin alcohol using a linking compound for linking at least two hydroxyl groups.

According to another aspect of the invention, a thickening agent including an alkoxylated rosin alcohol alkoxylated with 0-200 moles of at least one alkylene oxide selected from ethylene oxide, propylene oxide, butylene oxide, and combinations thereof per mole of alcohol and reacted with a linking compound for linking at least two hydroxyl groups is provided.

According to another aspect of the invention, a method for thickening an emulsion polymer or a polymer dispersion, or a paint or coating composition, includes adding from about 0.1% to about 10% by weight of the agent obtained to an emulsion polymer or polymer dispersion, or paint or coating composition.

According to another aspect of the invention, a method for modifying the surface tension includes adding from about 0.1% to about 10% by weight of the agent obtained to an emulsion polymer or polymeric dispersion, or a paint or coating composition.

### DETAILED DESCRIPTION OF THE INVENTION

As used herein, the terms “comprises”, “comprising”, “includes”, “including”, “has”, “having”, or any other variation thereof, are intended to cover non-exclusive inclusions. For example, a process, method, article or apparatus that comprises a list of elements is not necessarily limited to only those elements but may include other elements not expressly listed or inherent to such process, method, article, or apparatus. In addition, unless expressly stated to the contrary, the term “or” refers to an inclusive “or” and not to an exclusive “or”. For example, a condition A or B is satisfied by any one of the following: A is true (or present) and B is false (or not present); A is false (or not present) and B is true (or present); and both A and B are true (or present).

The terms “a” or “an” as used herein are to describe elements and components of the invention. This is done for convenience to the reader and to provide a general sense of the invention. The use of these terms in the description herein should be read and understood to include one or at least one. In addition, the singular also includes the plural unless indicated to the Contra. For example, reference to a composition containing “a compound” includes one or more compounds. As used in this specification and the appended claims, the term “or” is generally employed in its sense including “and/or” unless the content clearly dictates otherwise.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

Weight percent, percent by weight, and % by weight refer to the concentration of a substance and describe the weight of that substance divided by the weight of the composition and multiplied by 100.

According to an aspect of the invention, an alkoxylated rosin alcohol includes a rosin alcohol alkoxylated with 0-200 moles of at least one alkylene oxide selected from the group consisting of ethylene oxide, propylene oxide, butylene oxide, and combinations thereof per mole of alcohol. The alkoxylated rosin alcohol may include 1-20 moles of ethoxylate. The alkoxylated rosin alcohol may include 20-200 moles of ethoxylate. The alkoxylated rosin alcohol may include 40-170 moles of ethoxylate. The alkoxylated rosin alcohol may be incorporated into a composition as a wetting agent.

According to another aspect of the invention, a method for making a thickening agent includes (a) providing an alkoxylated rosin alcohol alkoxylated with 0-200 moles of at least one alkylene oxide selected from ethylene oxide, propylene oxide, butylene oxide, and combinations thereof per mole of alcohol; and (b) reacting the alkoxylated rosin alcohol using a linking compound for linking at least two hydroxyl groups. The method may include in step (b) reacting the alkoxylated rosin alcohol and linking compound with polyalkylene glycol. The polyalkylene glycol may be at least one compound selected from PEG 4000, PEG 4500, PEG 8000, and PEG 12000. Step (b) may further include providing equimolar quantities of alkoxylated rosin alcohol and linking compound to form a mixture, and reacting the mixture. The method may further include in step (b) providing selected ratios of the alkoxylated rosin alcohol and the linking group, where for each mole of alkoxylated rosin alcohol, 0.1 to 0.999 moles of linking group are used. The method may Her include in step (b) of reacting the alkoxylated rosin alcohol and linking compound with polyalkylene glycol, where 0 to 1 moles of polyalkylene glycol are used. In the method where the linking group is epihalohydrin, the reaction is carried out in the presence of a catalyst. In the method where the linking group is diisocyanate, the reaction is carried out in the presence of a catalyst. In the method where the linking group is dihaloalkane, the reaction is carried out in the presence of a caustic catalyst. In the method where the linking group is an acetal, the reaction is carried out in the presence of a caustic catalyst. In the method where the linking group is an aminoplast, the reaction is carried out in the presence of a catalyst.

According to another aspect of the invention, a thickening agent includes an alkoxylated rosin alcohol alkoxylated with 0-200 moles of at least one alkylene oxide selected from ethylene oxide, propylene oxide, butylene oxide, and combinations thereof per mole of alcohol and reacted with a linking compound for lining at least two hydroxyl groups. The agent may include 1-40 moles of ethoxylate. The agent may include 1-20 moles of ethoxylate. In the agent, the alkoxylated rosin alcohol and linking compound may be reacted with polyalkylene glycol. The agent may be incorporated into an aqueous industrial or household paint or coating. The agent may include 40-170 moles of alkoxylate. The agent may be incorporated into a composition as a rheology modifier.

According to another aspect of the invention, a method for thickening an emulsion polymer or a polymer dispersion includes the step of adding from about 0.1% to about 10% by weight of the thickening agent to an emulsion polymer or polymer dispersion.

According to another aspect of the invention, a method for thickening a paint or coating composition includes the step of adding from about 0.1% to about 10% by weight of the thickening agent to a paint or coating composition.

According to another aspect of the invention, a method for modifying the surface tension of a surface or liquid includes the step of adding from about 0.1% to about 10% by weight of the alkoxylated rosin alcohol to an emulsion polymer or polymer dispersion, or to a paint or coating composition. Alternatively, the alkoxylated rosin alcohol may be added in an amount of from about 1% to about 5%.

The rosin alcohol for use in the invention is hydroabietyl alcohol. The primary, monohydric, high molecular weight alcohol is a colorless, tacky, balsamic resin derived from hydrogenated rosin acids. A suitable rosin alcohol is available under the tradename ABITOL E, from Eastman.

The alcohol is a derivative of abietic acid, the structure of which is reproduced below:

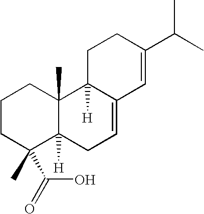

The rosin alcohol is alkoxylated with at least one suitable alkylene oxide, for example, ethylene oxide, propylene oxide, butylene oxide and combinations thereof in the presence of a catalyst. Suitable catalysts include sodium hydroxide (NaOH), sodium methoxide, and hydrotalcite. Advantageously, the alkoxylated rosin alcohol readily biodegrades into the environment with no adverse affects (it is a natural product), as opposed to alkylphenols. The alkoxylated rosin alcohol according to an aspect of the invention is advantageously a substitute for nonylphenol.

Not wishing to be bound or limited by a theory herein, it is believed that the size (fused ring structure) of the rosin alcohol causes it to behave similarly to nonylphenol as a rheology modifier. The fused aliphatic ring structure is bulky and hydrophobic, but is not particularly flexible, similar to the aromatic structure of alkylphenols.

The alkoxylated rosin alcohol may be linked to another alkoxylated rosin alcohol via a linking group according to an aspect of the invention. According to an aspect of the invention, the alcohols linked together are suitable as a thickening agent. As described above, the rosin alcohol may be alkoxylated with 1-100 moles of at least one alkylene oxide selected from the group consisting of ethylene oxide, propylene oxide, butylene oxide, and combinations thereof. By way of illustration, the rosin alcohol may be ethoxylated with 5-15 moles of ethylene oxide. When linked to another alkoxylated rosin alcohol with diisocyanate, the resulting product may be used, for example, as thickening agent.

Alternatively, the alkoxylated rosin alcohol may further be reacted with a polyalkylene glycol, and is also suitable as a rheology modifier (thickening agent). According to the invention there is provided a thickening agent comprising the addition reaction product of an alkoxylated rosin alcohol linked to a polyethylene glycol component. It should be understood that the resulting product is random, i.e., there may be one or more alkoxylated rosin alcohols adjacently linked, or one or more polyalkylene glycol molecules adjacently linked.

According to an aspect of the invention, the alkoxylated rosin alcohol may be reacted with an equal molar quantity of a linking compound, for example, diisocyanate, and the resulting product is reacted with a polyalkylene glycol at a 2:1 molar ratio. Alternatively, the resulting product may be reacted with polyalkylene glycol at a 1:1 molar ratio. When linked to the polyethylene glycol component with a linking compound, for example, epihalohydrin or diisocyanate, the resulting product may be used as a rheology modifier. When an epihalohydrin is used, a suitable solvent, including but not limited to toluene, may be used in the reaction. The resulting product, when stripped of any solvent and diluted with water and butyl cosolvent, performs at equal efficiency in thickening a latex paint to a given viscosity as a product made with nonylphenol ethoxylate.

Linking group L may be any linking compound capable of linking two hydroxyl groups. Thus, the linking compound must be at least difunctional. According to an aspect of the invention, suitable linking compounds include, but are not limited to diisocyanates, for example, toluene diisocyanate, isophorone diisocyanate, and methylene diphenyl diisocyanate; acetals, for example, dimethylbenzylacetal and diethylbenzene acetal; aminoplasts, for example, dimethylolurea and polymethylol melamine; dihaloalkanes, for example, dichloroethane, dichloropropane, and dibromomethane; urethane polyether thickeners, and epihalohydrin, for example, epichlorohydrin.

A suitable catalyst when a diisocyanate is used as a linking group includes an organo-tin compound including, for example, dibutyl tin dilaurate or tert-amine triethylamine. A suitable catalyst when epihalohydrin is used as the linking compound includes a caustic compound, for example, sodium hydroxide, potassium hydroxide, sodium methoxide, or a Lewis acid. A suitable catalyst when dihaloalkane is used as a linking compound includes, for example, dichloroethane or dibromomethane. A suitable catalyst when an acetal is used as a linking compound includes, for example, a caustic compound. It is understood by one skilled in the art of suitable catalysts when an aminoplast is used as a linking compound.

The polyalkylene glycol suitable for use according to the invention is at least difunctional. A suitable polyalkylene glycol is polyethylene glycol, and includes, but is not limited to, PEG 1000, PEG 4000, PEG 4500, PEG 8000, PEG 12000 and PEG 20000. PEG typically has a distribution of molecular weights. The numbers associated with PEG indicate the average molecular weight e.g., a PEG with n=80 has an average molecular weight of approximately 3500 Daltons and is identified as PEG 3500.

The thickening agent and/or wetting agent may also be useful in a variety of waterborne coating formulations, including, for example, household and industrial paints and household and industrial coatings including, but not limited to paper, floor, textile, ink, sealant, and adhesive applications. The wetting and/or thickening agent may include a biocide to prevent microbial growth, and other components that do not materially affect the basic characteristics and efficacy of the composition.

Unless otherwise defined, all technical and scientific terms used herein have the same meaning as commonly understood by one of ordinary skill in the art to which the invention belongs. The materials and methods are illustrative only and are not intended to be limiting. Methods and materials similar or equivalent to those described herein can be used in the practice or testing of the invention.

The invention has been described with reference to specific embodiments. One of ordinary skill in the art, however, appreciates that various modifications and changes can be made without departing from the scope of the invention as set forth in the claims. For example, although certain linking groups and catalysts are described, other linking groups and catalysts may be suitable according to the invention. Accordingly, the specification is to be regarded in an illustrative manner, rather than a restrictive view and all such modifications are intended to be included within the scope of the invention.

Benefits, other advantages, and solutions to problems have been described above with regard to specific embodiments. The benefits, advantages, solutions to problems and any element(s) that may cause any benefit, advantage, or solution to occur or become more pronounced are not to be construed as a critical, required, or essential feature or element of any or all of the claims.

What is claimed is:

1. An alkoxylated rosin alcohol, comprising a rosin alcohol alkoxylated with 0-200 moles of at least one alkylene oxide selected from the group consisting of ethylene oxide, propylene oxide, butylene oxide, and combinations thereof per mole of alcohol.

2. The alkoxylated rosin alcohol according to claim 1, comprising 1-20 moles of ethoxylate.

3. The alkoxylated rosin alcohol according to claim 1, comprising 20-200 moles of ethoxylate.

4. A method for making a thickening agent, comprising:
(a) providing an alkoxylated rosin alcohol alkoxylated with 0-200 moles of at least one alkylene oxide selected from the group consisting of ethylene oxide, propylene oxide, butylene oxide, and combinations thereof per mole of alcohol; and
(b) reacting the alkoxylated rosin alcohol using a linking compound for linking at least two hydroxyl groups.

5. The method according to claim 4, wherein step (b) further comprises reacting the alkoxylated rosin alcohol and linking compound with polyalkylene glycol.

6. The method according to claim 5, wherein the polyalkylene glycol is at least one compound selected from the group consisting of PEG 4000, PEG 4500, PEG 8000, and PEG 12000.

7. The method according to claim 4, wherein step (b) further comprises providing equimolar quantities of alkoxylated rosin alcohol and linking compound to form a mixture and reacting the mixture.

8. The method according to claim 4, wherein step (b) further comprises providing selected ratios of the alkoxylated rosin alcohol and the linking group, wherein for each mole of alkoxylated rosin alcohol, 0.1 to 0.999 moles of linking group are used.

9. The method according to claim 8, wherein step (b) further comprises reacting the alkoxylated rosin alcohol and linking compound with polyalkylene glycol, wherein 0 to 1 moles of polyalkylene glycol is used.

10. The method according to claim 4, wherein the linking group is epihalohydrin and the reaction is carried out in the presence of a catalyst.

11. The method according to claim 4, wherein the linking group is diisocyanate and the reaction is carried out in the presence of a catalyst.

12. The method according to claim 4, wherein the linking group is dihaloalkane and the reaction is carried out in the presence of a caustic catalyst.

13. The method according to claim 4, wherein the linking group is an acetal and the reaction is carried out in the presence of a caustic catalyst.

14. The method according to claim 4, wherein the linking group is an aminoplast and the reaction is carried out in the presence of a catalyst.

15. A thickening agent comprising an alkoxylated rosin alcohol alkoxylated with 0-200 moles of at least one alkylene oxide selected from the group consisting of ethylene oxide, propylene oxide, butylene oxide, and combinations thereof per mole of alcohol and reacted with a linking compound for linking at least two hydroxyl groups.

16. The agent according to claim 15, comprising 140 moles of ethoxylate.

17. The agent according to claim 15, wherein the alkoxylated rosin alcohol and linking compound is reacted with polyalkylene glycol.

18. The agent according to claim 15, comprising 40-170 moles of alkoxylate.
